(19) United States
(12) Patent Application Publication
(10) Pub. No.: US 2008/0064850 A1
(43) Pub. Date: Mar. 13, 2008

(54) Thermosetting Powder Coating and Process for Producing the Same

(75) Inventors: Daiske Kawaguchi, Osaka (JP); Hisaki Tanabe, Osaka (JP); Masami Yabuta, Osaka (JP); Kazuyuki Kuwano, Aichi (JP)

Correspondence Address: FITCH, EVEN, TABIN & FLANNERY, P. O. BOX 18415, WASHINGTON, DC, 20036, US

(73) Assignees: Nippon Paint Co., Ltd., Osaka--shi (JP); Toyota Jidosha Kabushiki Kaisha, Toyota-shi (JP)

(21) Appl. No.: 11/628,317

(22) PCT Filed: May 30, 2005
(86) PCT No.: PCT/JP05/10281

§ 371 Date: Dec. 1, 2006

(30) Foreign Application Priority Data
Jun. 2, 2004 (JP) 2004-164117

(51) Int. Cl. C08G 18/00; C08F 20/32; C08G 18/62; C08G 18/80; C09D 175/04

(52) U.S. Cl. 528/363

(57) ABSTRACT

Provided is a thermosetting powder coating obtained by the following procedure: preparing a suspension by dispersing a resin solution containing an organic solvent into an aqueous solution containing a water-soluble polymer; removing the organic solvent in a dispersed phase from the suspension; solidifying particles in the dispersed phase; and removing the solidified particles in the dispersed phase from the suspension. The thermosetting powder coating is characterized in that the resin solution contains: acrylic resin containing epoxy groups and blocked isocyanate groups; and, as a curing agent, a carboxylic group- or carboxylic anhydride group-containing compound.

### TECHNICAL FIELD

The present invention relates to a thermosetting powder coating produced by a wet process, and to a process for producing the same.

### BACKGROUND ART

Powder coatings have received widespread attention as contribute to the protection of the environment coatings because they never emit organic solvents in the atmosphere. Among such powder coatings, thermosetting powder coatings have been particularly used in view of their excellent coated film performance and properties. In recent years, thermosetting powder coatings are required that provide coated films with excellent appearance and greater performance, which can be applied to automobile bodies.

Such thermosetting powder coatings are heated and melted in coating processes to form coated films. There has been a problem that coatings obtained by heating and melting the thermosetting powder coatings cannot provide appropriate flow property, and therefore they cannot provide coated films with as excellent a surface smoothness as solvent-based coatings can. Meanwhile, materials with a lower melting point or materials with a lower molecular weight are used to have good property of flow viscosity of thermosetting powder coatings. Thus, flow property of coatings at a time of a heating and melting process is increased. In this case, surface smoothness of the resultant coated films is improved. However, there has been a problem that storage stability of powder coatings, such as blocking resistance and resistance to solid phase reactivity, is reduced.

In order to solve these problems, Japanese Patent Laid-Open Gazette No. 2003-105264 (Document 1) discloses thermosetting powder coating composition that can be produced from two types of thermosetting resin by a so-called wet process, the thermosetting resin having a predetermined SP value, glass transition temperature, number average molecular weight and viscosity. Such thermosetting powder coating composition described in Document 1 could exhibit improved performance in terms of storage stability and surface smoothness of a coated film.

However, the thermosetting powder coating composition described in Document 1 do not necessarily have sufficient low-temperature cure properties and therefore they required to be baked at high temperatures, accordingly those coated film provides yellowing and popping in some cases. For this reason, these coating composition are not necessarily suited for thermosetting powder coatings that are particularly applied for pale colors. It should be noted that so-called “popping” is referred to as a phenomenon in which pinholes are undesirably generated in coatings when they release solvents at a time of heating and melting processes.

Although use of thermosetting powder coatings that are disclosed in Japanese Patent Laid-Open Gazette No. Hei 11-116854 (Document 2), Japanese Patent Laid-Open Gazette No. 2003-176450 (Document 3) and Japanese Patent Laid-Open Gazette No. 2003-286445 (Document 4) can improve low-temperature cure properties, there has been a problem that the thermosetting powder coatings described in these Documents 2 to 4 do not show excellent storage stability of powder coating composition, such as blocking resistance and resistance to solid phase reactivity.

### DISCLOSURE OF THE INVENTION

The present invention has been accomplished in light of the foregoing problems of the prior art, and an object thereof is to provide a thermosetting powder coating and a process for producing the same, the thermosetting powder coating having sufficiently enhanced low-temperature cure property, effectively preventing occurrence of yellowing and so-called popping to allow for provision of a coated film with high-grade crosslink density and appearance even when baked and cured at a relatively low temperature, and being suited for application for pale colors as well as deep colors, all of which can be achieved in spite of the fact that the thermosetting powder coating is produced by a so-called wet process.

The present inventors have diligently pursued research to accomplish the foregoing object. As a result, these objects can be accomplished by (I) using acrylic resin which contains epoxy groups and blocked isocyanate groups, and a carboxylic group- or carboxylic anhydride group-containing compound in combination, or by (II) using epoxy group-containing acrylic resin, a carboxylic group- or carboxylic anhydride group-containing compound and a blocked multifunctional isocyanate compound in combination. Thus, they have completed the present invention.

Specifically, the first thermosetting powder coating of the present invention is obtained by the following procedure: preparing a suspension by dispersing a resin solution containing some organic solvent into an aqueous solution containing a water-soluble polymer; removing the organic solvent in a dispersed phase from the suspension; solidifying particles in the dispersed phase; and removing the solidified particles in the dispersed phase from the suspension. The first thermosetting powder coating is characterized in that the resin solution contains: acrylic resin containing epoxy groups and blocked isocyanate groups; and, as a curing agent, a carboxylic group- or carboxylic anhydride group-containing compound.

Moreover, the first process for producing a thermosetting powder coating includes the steps of: preparing a suspension by dispersing a resin solution containing an organic solvent into an aqueous solution containing a water-soluble polymer; removing the organic solvent in a dispersed phase from the suspension; solidifying particles in the dispersed phase; and removing the solidified particles in the dispersed phase from the suspension. The first process is characterized in that the resin solution contains: acrylic resin containing epoxy groups and blocked isocyanate groups; and, as a curing agent, a carboxylic group- or carboxylic anhydride group-containing compound.

For the isocyanate group according to the present invention, a tertiary isocyanate group is preferable.

Moreover, the second thermosetting powder coating of the present invention is obtained by the following procedure: preparing a suspension by dispersing a resin solution containing an organic solvent into an aqueous solution containing a water-soluble polymer; removing the organic solvent in a dispersed phase from the suspension; solidifying particles in the dispersed phase; and removing the solidified particles in the dispersed phase from the suspension. The second thermosetting powder coating is characterized in that the resin solution contains: epoxy group-containing acrylic resin; a carboxylic group- or carboxylic anhydride group-containing compound as a first curing agent; and a blocked multifunctional isocyanate compound as a second curing agent, and that the content of the blocked multifunctional isocyanate compound is 0.3 to 20% by weight relative to the solid content of the coating to be prepared.

Moreover, the second process for producing a thermosetting powder coating includes the steps of: preparing a suspension by dispersing a resin solution containing an organic solvent into an aqueous solution containing a water-soluble polymer; removing the organic solvent in a dispersed phase from the suspension; solidifying particles in the dispersed phase; and removing the solidified particles in the dispersed phase from the suspension. The second process is characterized in that the resin solution contains: epoxy group-containing acrylic resin; a carboxylic group- or carboxylic anhydride group-containing compound as a first curing agent; and a blocked multifunctional isocyanate compound as a second curing agent, and that the content of the blocked multifunctional isocyanate compound is 0.3 to 20% by weight relative to the solid content of the coating to be prepared.

The blocked multifunctional isocyanate compound according to the present invention is preferably at least one selected from the group consisting of a diisocyanate compound having a tertiary isocyanate group, an adduct of the diisocyanate compound and an isocyanurate of the diisocyanate compound.

Moreover, in the first and second processes for producing a thermosetting powder coating, the water-soluble polymer is preferably a mixture of a water-soluble polymer with no cloud point and a water-soluble polymer with a cloud point in a range of 30 to 90° C. In this case, the first and second processes preferably includes the steps of (1) preparing a suspension by dispersing a resin solution containing the organic solvent into an aqueous solution containing the water-soluble polymer at a temperature below the cloud point; (2) heating the suspension to a temperature below the cloud point to form primary particles in the dispersed phase; (3) heating the suspension containing the primary particles to a temperature the cloud point or above, whereby the primary particles are aggregated to form secondary particles, as well as removing an organic solvent in the secondary particles to solidify the particles; and (4) removing the solidified particles in the dispersed phase from the suspension.

According to the present invention, it is possible to provide a thermosetting powder coating and a process for producing the same, the thermosetting powder coating having sufficiently enhanced low-temperature cure property, effectively preventing occurrence of yellowing and so-called popping to allow for provision of a coated film with high-crosslink density and appearance even when baked and cured at a relatively low temperature, and being suited for application for pale colors as well as deep colors, all of which can be achieved in spite of the fact that the thermosetting powder coating is produced by a so-called wet process.

### BEST MODE FOR CARRYING OUT THE INVENTION

Hereinafter, a thermosetting powder coating of the present invention and a process of the present invention for producing a thermosetting powder coating will be described in detail in line with the preferred embodiments.

[First Process for Producing a Thermosetting Powder Coating]

The first process of the present invention for producing a thermosetting powder coating includes the steps of: preparing a suspension by dispersing a resin solution containing an organic solvent into an aqueous solution containing water-soluble polymers; removing the organic solvent in the dispersed phase from the suspension; solidifying particles in the dispersed phase; and removing the solidified particles in the dispersed phase from the suspension. The first process is characterized in that the resin solution contains: acrylic resin containing epoxy groups and blocked isocyanate groups; and, as a curing agent, a carboxylic group- or carboxylic anhydride group-containing compound.

As described above, the resin solution according to the present invention contains an organic solvent, and further contains: acrylic resin containing epoxy groups and blocked isocyanate groups; as a curing agent and a carboxylic group- or carboxylic anhydride group-containing compound. It should be noted that the term “blocked isocyanate group” means an isocyanate group blocked with a protective group, where heat or moisture can decouple the protective group to generate the isocyanate group.

The acrylic resin used in the present invention, which contains epoxy groups and blocked isocyanate groups, can be provided by copolymerizing an epoxy group-containing acrylic monomer, a polymerizable isocyanate compound and monomers those do not react with the epoxy group-containing monomer in accordance with a normal procedure, and by mixing a blocking agent with the resultant solution to block isocyanate groups.

For such an epoxy group-containing monomer, monomers that include at least one epoxy group in one molecule may be used, and examples thereof include glycidyl acrylate, glycidyl methacrylate and 2-methylglycidyl methacrylate.

The polymerizable isocyanate compound is not particularly limited as long as it can be polymerized with an epoxy group-containing monomer. However, from the view point of higher reactivity, aromatic isocyanate compounds having isopropenyl groups and aliphatic isocyanate compounds having isopropenyl groups are preferable, and polymerizable isocyanate compounds represented by the following general formula are more preferable. 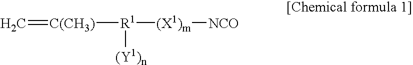
(where R¹ represents a group selected from the group consisting of a phenyl group, a naphthyl group and a cyclohexyl group, Y¹ represents an alkyl group having 1 to 4 carbon atoms, X¹ represents an alkylene group having 1 to 12 carbon atoms, m represents 0 or 1, and n represents an integer of 0 to 4)

In this general formula, Y¹ represents an alkyl group having 1 to 4 carbon atoms. However, Y¹ preferably represents a methyl group. Moreover, X¹ represents an alkylene group having 1 to 12 carbon atoms. However, X¹ preferably represents a methylene group, an ethylene group, a propylene group or an isopropylene group. In particular, X¹ preferably represents an isopropylene group. In addition, specific examples of such polymerizable isocyanate compounds include tolylene-2-isopropenyl-4-isocyanate, tolylene-4-isopropenyl-2-isocyanate, tolylene-2-isopropenyl-6-isocyanate, 4-isopropenyl-1-methylcyclohexane-2-isocyanate, 2-isopropenyl-1-methylcyclohexane-4-isocyanate, 2-isopropenyl-1-methylcyclohexane-6-isocyanate, 1-isopropenylnaphthalene-5-isocyanate, 1-isopropenylbenzene-4-isocyanate (p-phenylene isopropenyl isocyanate), 3-isopropenylbenzyl isocyanate, and 1-isopropenylbenzene-3-isopropyl isocyanate. For such polymerizable isocyanate compounds, from the view point of higher reactivity, polymerizable isocyanate compounds are preferable that have the above-described general formula in which X¹ represents a tertiary isocyanate group (particularly preferably an isopropylene group). It should be noted that the tertiary isocyanate group means an isocyanate group attached to the carbon atom holding three other substituent groups, meaning an isocyanate group having a so-called tertiary carbon atom.

Furthermore, examples of monomers that are not reactive with epoxy group-containing monomers include methyl (meth)acrylate, ethyl (meth)acrylate, n-butyl (meth)acrylate, iso-butyl (meth)acrylate, tert-butyl (meth)acrylate, hydroxyethyl (meth)acrylate, hydroxypropyl (meth)acrylate, hydroxybutyl acrylate, styrene, vinyl toluene and p-chlorostyrene.

Examples of blocking agents include phenol compounds such as phenol, crezol, ethylphenol and butylphenol, alcohol compounds such as 2-hydroxypyridine, butylcellosolve, propylene glycol monoethyl ether, benzyl alcohol, methanol, ethanol, n-butanol, isobutanol and 2-ethylhexanol, active methylene compounds such as dimethyl malonate, diethyl malonate, methyl acetoacetate, ethyl acetoacetate and acetylacetone, mercaptan compounds such as butyl mercaptan and dodecyl mercaptan, acid amide compounds such as acetanilide and acetic acid amide, lactam compounds such as ε-caprolactam, δ-valerolactam and γ-butyrolactam, imidazole compounds such as imidazole and 2-methyl imidazole, urea compounds such as urea, thiourea and ethylene urea, oxime compounds such as formamide oxime, acetoaldoxime, acetone oxime, methylethyl ketoxime, methyl isobutyl ketoxime and cyclohexanone oxime, and amine compounds such as diphenylamine, aniline, carbazole, ethyleneimine and polyethyleneimine.

Moreover, when an epoxy group-containing monomer (A), a polymerizable isocyanate (B) and a monomer that is not reactive with the epoxy group-containing monomer (C) are copolymerized, the mixing ratio of the epoxy group-containing monomer (A) and the monomer that is not reactive with the epoxy group-containing monomer (C), that is, (A):(C) is preferably in a range of 70:30 to 30:70, more preferably in a range of 55:45 to 45:55 on a solid weight basis. If the mixing ratio of (C) is below the range, the resultant coated film tends to show reduced transparency. Meanwhile, if the mixing ratio of (C) exceeds the range, thermosetting property tends to be reduced to cause reduction in coated film performance.

Moreover, after an epoxy group-containing monomer, a polymerizable isocyanate and a monomer that is not reactive with the epoxy group-containing monomer are copolymerized, a blocking agent is then mixed therewith to form acrylic resin. This acrylic resin preferably has a number-average molecular weight of 1,000 to 4,000, more preferably 2,000 to 4,000. This is because too low number-average molecular weight may cause powders to show reduced blocking resistance, and meanwhile, too high number-average molecular weight may increase melting viscosity to cause deterioration in appearance.

Moreover, the carboxylic group- or carboxylic anhydride group-containing compound to be used as a curing agent in the present invention is preferably a polycarboxylic acid or an anhydrides thereof, both of which are crystalline solids at room temperature. Specific examples thereof include polycarboxylic acids such as aliphatic polycarboxylic acids and aromatic polycarboxylic acids and anhydrides thereof. Here, the term “room temperature” means about 25° C.

Examples of such aliphatic polycarboxylic acids include decandicarboxylic acid, adipic acid, maleic acid, malonic acid, ethylmalonic acid, butylmalonic acid, dimethylmalonic acid, succinic acid, methylsuccinic acid, dimethylsuccinic acid, glutaric acid, methylglutaric acid, dimethylglutaric acid, sebacic acid, azelaic acid, pimellic acid, suberic acid, 1,11-undecanedicarboxylic acid, dodecanedicarboxylic acid, hexadecanedicarboxylic acid, 3-iso-octylhexanedicarboxylic acid, cyclohexanedicarboxylic acid, butanetricarboxylic acid, butanetetracarboxylic acid, citric acid and tricarbazinic acid. Moreover, examples of aromatic polycarboxylic acids include phthalic acid. In addition, examples of anhydrides of these polycarboxylic acids include succinic anhydride, tetrahydrophthalic anhydride and phthalic anhydride.

In addition to the polycarboxylic acids described above, synthetic polycarboxylic acids can be used as long as they are crystalline solids at room temperature. For such synthetic polycarboxylic acids, compounds that can be obtained by the reaction between polyalcohols and acid anhydrides can be cited. Specific examples thereof include butanediol succinate obtained from butanediol and succinic anhydride, hexanediol succinate obtained from hexanediol and succinic anhydride, nonanediol succinate obtained from nonanediol and succinic anhydride, and a 1:1:1 adduct of neopentyl glycol, trimellitic anhydride and succinic anhydride.

Moreover, one or more types of the above-described polycarboxylic acids and anhydrides thereof, which are crystalline solids at room temperature, can be mixed for use as the carboxylic group- or carboxylic anhydride group-containing compound to be used as a curing agent in the present invention. In addition, carboxylic acids that are different from the above-described polycarboxylic acids and anhydrides thereof can be further mixed with the mixture of the polycarboxylic acids and anhydrides thereof which are crystalline solids at room temperature for use as the curing agent according to the present invention. For such carboxylic acids, polycarboxylic acids that are non-crystalline solids or liquid at room temperature, and monocarboxylic acids that may be present in any form at room temperature can be cited. Specific examples thereof include aliphatic monocarboxylic acids such as sebacic acid, lauric acid, stearic acid and 8-ethyloctadecanoic acid, and a 1:2 adduct of nonanediol and hexahydrophthalic anhydride, which are liquid at room temperature. Two or more types of such carboxylic acids may be used.

Moreover, a process of mixing a polycarboxylic acid with a carboxylic acid that is different from the polycarboxylic acid is not particularly limited. However, the following processes are preferable: a process of reducing each particle diameter before mixing; and a process of dissolving the polycarboxylic acid and the carboxylic acid into a solvent or the like before mixing so that they are liquid.

Moreover, for the organic solvent according to the present invention, organic solvents that are not miscible with water, that is, organic solvents having a water-solubility of 10% by weight or less are preferably used. Specific examples thereof include xylene, toluene, cyclohexane and ethyl acetate.

Moreover, it is preferable that the solid content of resin contained in a resin solution be adjusted to be in a range of 10 to 80% by weight, more preferably in a range of 20 to 50% by weight. If the solid content of the resin is below the lower limit, solution viscosity tends to be reduced, resulting in a great amount of coarse particles. Meanwhile, if the solid content of the resin exceeds the upper limit, solution viscosity tends to be increased to generate a great amount of fine particles.

Moreover, a resin solution prepared by further adding another resin to acrylic resin which contains epoxy groups and isocyanate groups can be suitably used as the resin solution used in the present invention. Hereinafter, resins that are combined and contained in the solution in this way will be described as “resin A” and “resin B.” The acrylic resin containing epoxy groups and blocked isocyanate groups may be resin A and another resin described above may be resin B, and vice versa.

When resin solutions are prepared by using the resins A and B, it is preferable that the difference in the SP value between the resins A and B, that is, (SP value of resin A)−(SP value of resin B) value be within a range of 0.1 to 1.0. If the difference in the SP value between the resins A and B is less than 0.1, blocking resistance tends to be reduced at a time of storage. If it is greater than 1.0, the compatibility between the resins A and B becomes poor, the appearance of a coated film tends to be deteriorated because a surface smoothness is not provided. Further, when such resins A and B are used, the resin A has a greater SP value than the resin B. For this reason, as particles in a dispersed phase, relatively, the resin A is positioned at the periphery of the dispersed phase and the resin B is positioned inside the phase.

Moreover, the resin A preferably has a glass transition is temperature of 50 to 100° C. and a number-average molecular weight of 2,000 to 4,000. Furthermore, the resin B preferably has a glass transition temperature of 20 to 70° C. and a number-average molecular weight of 1,000 to 4,000. If the glass transition temperature and number-average molecular weight of the resins A and B are below the ranges, blocking resistance tends to be reduced. Meanwhile, if the glass transition temperature and the number-average molecular weight of the resins A and B exceed the ranges, melting viscosity tends to be increased to cause deterioration in the appearance of a coated film. Further, if the glass transition temperature and the number-average molecular weight of the resins A and B are out of the ranges, the compatibility between the resins A and B becomes poor to cause deterioration in the appearance of a coated film. As described above, when a resin A with a (number-average molecular weight/100+glass transition temperature) value of 90 or above, and a resin B with a (number-average molecular weight/100+glass transition temperature) value of 89 or less are used, in the resultant thermosetting powder coating, the relatively hard resin A is placed around the relatively soft resin B because the resin A is harder than resin B. Thus, the resultant thermosetting powder coating has excellent blocking resistance and may provide a coated film with excellent surface smoothness because, as a whole, particles have reduced melting viscosity.

Moreover, it is preferable that resin A/resin B value, that is, the ratio of solid content of the resin A to that of resin B be in a range of 5/95 to 50/50, and that the thermosetting powder coating has a viscosity of 40 mPa s or less at 140° C. in a rising temperature test. If the content of the resin A is below the lower limit, blocking resistance tends to be reduced. Meanwhile, if the content of the resin A exceeds the upper limit, a melting viscosity tends to be increased to cause deterioration in the appearance of a coated film.

When resin solutions are prepared by using two types of resins A and B as described above, the resultant thermosetting powder coating preferable has a viscosity of 40 mPa s or less at 140° C. in a rising temperature test. If the viscosity exceeds this range, an excellent surface smoothness cannot be provided to a coated film, deteriorating the appearance of the coated film. Furthermore, the resin A preferably has a viscosity of 500 mPa s or above at 140° C. in a rising temperature test. If the viscosity is below this range, blocking resistance tends to be reduced. Furthermore, the resin B preferably has a viscosity of 300 mPa s or less at 140° C. in a rising temperature test. If the viscosity exceeds this range, melting viscosity tends to be increased to cause deterioration in the appearance of a coated film.

Moreover, it is preferable that curing agents be dispersed into resin solutions in a solid state. Furthermore, preferred specific example of the resin A includes epoxy group-containing acrylic resin.

Moreover, when resin solutions are prepared by using the resins A and B, a resin A solution and resin B solution can be separately added into respective aqueous solutions containing water-soluble polymers. However, before adding the resin A solution and the resin B solution to the respective aqueous solutions containing water-soluble polymers, they are preferably mixed with each other to form one thermosetting resin solution, and the solution is preferably added to an aqueous solution containing water-soluble polymers.

Moreover, the water-soluble polymer according to the present invention may be either a water-soluble polymer with no cloud point or a water-soluble polymer with a cloud point in a range of 30 to 90° C. Furthermore, these water-soluble polymers may be used in combination. Among these water-soluble polymers, a water-soluble polymer obtained by mixing two types of water-soluble polymers, that is, a water-soluble polymer with no cloud point and a water-soluble polymer with a cloud point in a range of 30 to 90° C. can be suitably used because the particle diameter of the resultant particles contained in the dispersed phase can be controlled.

Specific examples of such water-soluble polymers with no cloud point include fully-saponified polyvinyl alcohols, partially-saponified polyvinyl alcohols with a degree of saponification of 85% or above, ethylcellulose, hydroxyethyl cellulose, and polyethylene glycol, which never show cloud point phenomenon at 100° C. or less when aqueous solutions thereof are heated. Only one type of such water-soluble polymers with no cloud point may be used. Alternatively, two or more types of such water-soluble polymers may be used in combination.

Moreover, specific examples of water-soluble polymers with a cloud point in a range of 30 to 90° C. include polyvinyl alcohol polymers which partially contains hydrophobic groups, such as partially-saponified polyvinyl alcohols with a degree of saponification of less than 85%, partially-formalized polyvinyl alcohols with a degree of saponification of less than 85% and an ethylene-vinyl alcohol copolymer, cellulose derivatives such as methylcellulose and hydroxypropylcellulose, and polyethylene glycol alkyl ether and an ethyleneglycol/propyleneglycol block copolymer, which exhibit cloud point phenomenon in a range of 30 to 90° C. when aqueous solutions thereof are heated. In addition, water-soluble polymers having a cloud point in a range of 30 to 90° C., which are obtained by adding electrolytes to the above-described water-soluble polymers with no cloud point, may also be used.

Moreover, for an aqueous solvent to which a water-soluble polymer is added, ion-exchanged water can be cited. The water-soluble polymers described above are added to such solvents to prepare aqueous solutions containing water-soluble polymers. Note that, when such aqueous solutions containing water-soluble polymers are prepared, the water-soluble polymers are preferably added in the solutions in a concentration of about 0.02 to 20% by weight. Moreover, the ratio of a water-soluble polymer having no cloud point to a water-soluble polymer having a cloud point in a range of 30 to 90° C. is preferably in a range of 99/1 to 10/90 on a solid weight basis. Pigments, various additives and other components may be optionally added to such aqueous solutions containing water-soluble polymers.

In the first process for producing a thermosetting powder coating, firstly, a suspension is prepared by dispersing a resin solution containing an organic solvent into an aqueous solution containing a water-soluble polymer.

Here, the suspension can be prepared as follows: a resin solution containing an organic solvent is added into an aqueous solution containing water-soluble polymers; and the resultant mixture is agitated and mixed to cause the resin solution containing the organic solvent to be dispersed into the aqueous solution containing the water-soluble polymer. When the suspension is prepared in this way, a dispersed phase is formed in the suspension in which a resin solution is dispersed.

Moreover, the mixture can be agitated and mixed as follows: the mixture is agitated and mixed by use of an emulsifying device (e.g., a homomixer or a homogenizer) that provides mechanical shearing force at a temperature below the cloud point of the water-soluble polymer.

Moreover, when the first thermosetting powder coating is produced by utilizing the cloud point of the water-soluble polymer, the suspension described above is preferably prepared at a temperature below the cloud point. Note that, when two or more types of water-soluble polymers having a cloud point in a range of 30 to 90° C. are used in combination, the lower cloud point holds a predominant position. Accordingly, a suspension of the water-soluble polymers should be prepared at a temperature below the lowest cloud point.

Moreover, when the first thermosetting powder coating is produced by controlling the particle diameter using a cloud point of the water-soluble polymer, after having prepared a suspension, the suspension is heated below the cloud point temperature, thereby forming primary particles in the dispersed phase. The primary particles thus formed preferably have a volume average particle diameter of 15 μm or less. When forming the primary particles, a part of the organic solvent is preferably removed in advance. The organic solvent is preferably removed at a low temperature, which is achieved by decreasing the pressure in the system. In this case, the organic solvent is preferably removed so that the particles in the dispersed phase have 30% or less by weight of the organic solvent. Note that, the primary particles can be randomly sampled to measure its particle diameter. Subsequently, the suspension containing the primary particles is heated to the cloud point temperature or above, whereby the primary particles are aggregated to form secondary particles. In this way, particles are controlled to have a desired particle diameter.

Next, in the first process of the present invention for producing a thermosetting powder coating, the organic solvent contained in the dispersed phase of the suspension is removed to solidify the particles in the dispersed phase, followed by separation of the solidified particles contained in the dispersed phase from the suspension.

Here, normal methods, such as suction filtration, can be used for removal of the organic solvent. The organic solvent is removed from the particles in the dispersed phase in this way. Thus, the particles in the dispersed phase are solidified.

Moreover, removal of the organic solvent, which is performed when the first thermosetting powder coating is produced by utilizing a cloud point of the water-soluble polymer, can be performed by heating and/or pressure reduction. Furthermore, resin contained in the secondary particles is thermosetting resin. For this reason, preferably, the temperature at which the organic solvent is removed is reduced as low as possible. With this fact taken into consideration, the organic solvent is preferably removed at a low temperature by decreasing the pressure.

Moreover, general methods can be employed to separate the solidified particles contained in the dispersed phase from the suspension. Specific examples thereof include, but not limited to, a method of separating the solidified particles by filtration, and a method of separating the solidified particles by centrifuge. The particles thus separated are washed and dried. In this way, a final thermosetting powder coating is provided.

[First Thermosetting Powder Coating]

The first thermosetting powder coating of the present invention can be provided in the following procedure: a resin solution containing an organic solvent is dispersed into an aqueous solution containing a water-soluble polymer to prepare a suspension; the organic solvent in a dispersed phase of the suspension is removed to solidify particles in the dispersed phase; and the solidified particles in the dispersed phase are removed from the suspension. The first thermosetting powder coating is characterized in that the resin solution contains: acrylic resin containing epoxy groups and blocked isocyanate groups; and a carboxylic acid group- or carboxylic anhydride group-containing compound as a curing agent.

Such a first thermosetting powder coating can be produced by the above-described first process for producing a thermosetting powder coating. The volume average particle diameter of the thermosetting powder coating is not particularly limited. However, from the view point of production efficiency and surface smoothness of the resultant coated film, the thermosetting powder coating preferably has the volume average particle diameter of 5 to 30 μm. If the volume average particle diameter is less than 5 μm, production efficiency and coating efficiency at a time of a coating process tend to be reduced. Meanwhile, if it is greater than 30 μm, the resultant coated film tends to have a poor surface smoothness.

Moreover, components, which are derived from the acrylic resin containing epoxy groups and blocked isocyanate groups, are preferably contained in the first thermosetting powder coating at a concentration of 30 to 80% by weight relative to the solid content of the thermosetting powder coating. If the content of these components is below the lower limit, thermosetting property tends to be reduced. Meanwhile, if it exceeds the upper limit, blocking resistance of the coating tends to be reduced.

Moreover, components, which are derived from the carboxylic group- or carboxylic anhydride group-containing compound, are preferably contained in the first thermosetting powder coating at a concentration of 10 to 60% by weight relative to the solid content of the thermosetting powder coating. If the content of these components is below the lower limit, thermosetting property tends to be reduced. Meanwhile, if it exceeds the upper limit, blocking resistance of the coating tends to be reduced.

Furthermore, components, which are derived from a polymerizable isocyanate compound used for preparation of the acrylic resin containing epoxy groups and blocked isocyanate groups, are preferably contained in the first thermosetting powder coating at a concentration of 0.3 to 20% by weight relative to the solid content of the thermosetting powder coating. If the content of these components is below the lower limit, cure property tends to be reduced to cause reduction in the coated film performance. Meanwhile, if it exceeds the upper limit, yellowing and popping tend to occur at a time of a baking process.

Moreover, pigments and various additives may be optionally added to the first thermosetting powder coating. Specific examples of such pigments include color pigments such as titanium dioxide, iron oxide red, yellow iron oxide, carbon black, phthalocyanine blue, phthalocyanine green, group of quinacridone pigment and group of azo pigment, and extending pigments such as talc, silica, calcium carbonate and barium sulfate precipitated. In addition, specific examples of additives include: fluidizing agents such as AEROSIL 130, AEROSIL 200 (both manufactured by Japan Aerosil Co., Ltd); surface control agents such as silicones including dimethylsilicone and methylsilicone, acrylic oligomer and benzoins including benzoin and benzoin-derivatives; cure accelerators (or curing catalysts); charge control agents; ultraviolet absorbers; antioxidants; and pigment dispersants. Note that, when pigments, various additives and the like are intended to be added to the first thermosetting powder coating, they are preferably added at a concentration of 10% or less by weight relative to the solid content of the thermosetting powder coating.

[Second Process for Producing a Thermosetting Powder Coating]

The second process of the present invention for producing a thermosetting powder coating includes the steps of: preparing a suspension by dispersing a resin solution containing an organic solvent into an aqueous solution containing a water-soluble polymer; removing the organic solvent in the dispersed phase from the suspension; solidifying particles in the dispersed phase; and removing the solidified particles in the dispersed phase from the suspension. The second process is characterized in that the resin solution contains: epoxy group-containing acrylic resin; a carboxylic group- or carboxylic anhydride group-containing compound as a first curing agent; and a blocked multifunctional isocyanate compound as a second curing agent, and that the blocked multifunctional isocyanate compound is contained at a concentration of 0.3 to 20% by weight relative to the solid content of the coating to be prepared.

Specifically, acrylic resin used for such epoxy group-containing acrylic resin is not particularly limited as long as it has two or more epoxy groups in one molecule. For example, acrylic resin obtained by polymerizing an epoxy group-containing monomer such as glycidyl acrylate, glycidyl methacrylate or 2-methylglycidyl methacrylate with a monomer such as methyl (meth)acrylate, ethyl (meth)acrylate, n-butyl (meth)acrylate, iso-butyl (meth)acrylate, tert-butyl (meth)acrylate, hydroxyethyl (meth)acrylate, hydroxypropyl (meth)acrylate, hydroxybutyl acrylate, styrene, vinyl toluene or p-chlorostyrene, which are not reactive the above-described epoxy group containing-monomers, in accordance with a normal method can be suitably used.

Moreover, the epoxy equivalent weight of the solid content of the epoxy group-containing acrylic resin is preferably in a range of 100 to 1000 g/eq, more preferably in a range of 150 to 600 g/eq, and particularly preferably in a range of 200 to 400 g/eq. If the epoxy equivalent weight is less than 100 g/eq, storage stability of the resultant coating tends to be reduced. Meanwhile, if the epoxy equivalent weight is greater than 1,000 g/eq, the resultant coated film tends to show poor performance.

Moreover, a carboxylic group- or carboxylic anhydride group-containing compound that is similar to that used for production of the first thermosetting powder coating can be used as the first curing agent.

Moreover, a blocked multifunctional isocyanate compound obtained by reacting a multifunctional isocyanate compound with a blocking agent can be used as the second curing agent. A blocked multifunctional isocyanate compound that is solid at room temperature is preferable, because blocking resistance of the coating is reduced if it is liquid at room temperature.

For such multifunctional isocyanate compounds, aromatic multifunctional isocyanate compounds and aliphatic multifunctional isocyanate compounds can be cited. Among these, di- or tri-isocyanate compounds represented by the following general formula, as well as adducts and isocyanurates thereof are preferable.
(Y²)ᵣ—R²—[(X²)ₚ—NCO]_{q} [General Formula]
(where R² represents a group selected from the group consisting of a phenyl group, a naphthyl group, a cyclohexyl group and an alkyl group, Y² represents an alkyl group having 1 to 4 carbon atoms, X² represents an alkylene group having 1 to 12 carbon atoms, p represents 0 or 1, q represents 2 or 3, r represents an integer from 0 to 6, and groups represented as [(X²)ₚ—NCO] may be the same or different)

In this general formula, Y² represents an alkyl group having 1 to 4 carbon atoms. However Y² preferably represents a methyl group. X² represents an alkylene group having 1 to 12 carbon atoms. However, X² preferably represents a methylene group, an ethylene group, a propylene group, or an isopropylene group. In particular, X² preferably represents an isopropylene group. Specific examples of such multifunctional isocyanate compounds include 1-methylbenzene-2,4-diisocyanate or 1-methylbenzene-2,6-diisocynanate (tolylenediisocyanate), hexamethylenediisocyanate, isoholondiisocyanate, naphthalenediisocyanate, p-phenylenediisocyanate, xylidinediisocyanate and tetramethylxylylenediisocyanate, as well as adducts and isocyanurates thereof. In addition, for such multifunctional isocyanate compounds and adducts and isocyanurates thereof, diisocyanate compounds containing tertiary isocyanate groups, and adducts and isocyanurates thereof are preferable, because they have higher reactivity and can provide excellent coated film performance. Specific examples thereof include tetramethylxylylenediisocyanate as well as adducts and isocyanurates thereof.

Moreover, upon preparation of resin solutions, the blocked multifunctional isocyanate compound is added at a concentration of 0.3 to 20%, more preferably 2 to 10% by weight relative to the solid content of the thermosetting powder coating. If the content of the blocked multifunctional isocyanate compound relative to the solid content of the thermosetting powder coating is less than 0.3% by weight, sufficient coated film performance cannot be provided. Meanwhile, if it exceeds 20% by weight, yellowing and popping are triggered at a time of a baking process.

Moreover, a resin solution prepared by further adding another resin to epoxy group-containing acrylic resin can be suitably used as the resin solution used in the present invention. Resins that are combined and contained in the solution in this way will be described as “resin A” and “resin B.” The epoxy group-containing acrylic resin may be resin A and another resin described above may be resin B, and vice versa. With regard to such resins A and B, the SP value, the glass transition temperature, the number-average molecular weight, the (number-average molecular weight/100+glass transition temperature) value, the ratio of the solid content between resin A and resin B, and the viscosity of the resultant thermosetting powder coating are the same as those described in the above-described first process for producing a thermosetting powder coating.

Moreover, organic solvents and aqueous solutions containing water-soluble polymers, which are used for the second process according to the present invention for producing a thermosetting powder coating, are similar to those used in the first process for producing a thermosetting powder coating. Furthermore, a process for preparing resin solutions used for the second process in the present invention and a process for preparing aqueous solutions containing water-soluble polymers are similar to those described in the above-described first process for producing a thermosetting powder coating.

Next, in the second process for producing a thermosetting powder coating, firstly, a suspension is prepared by dispersing a resin solution containing an organic solvent into an aqueous solution containing a water-soluble polymer. The suspension is prepared by the process similar to that described in the first process for producing a thermosetting powder coating.

Next, the organic solvent in a dispersed phase of the suspension is removed to solidify particles in the dispersed phase. Thereafter, the solidified particles in the dispersed phase are separated from the suspension. The process for removing the organic solvent and the process for separating the particles in the dispersed phase from the suspension are similar to those described in the first process for producing a thermosetting powder coating.

[Second Thermosetting Powder Coating]

The second thermosetting powder coating of the present invention is produced by the second process for producing a thermosetting powder coating, which can be provided by the following procedure: a resin solution containing an organic solvent is dispersed into an aqueous solution containing a water-soluble polymer to prepare a suspension; the organic solvent in a dispersed phase of the suspension is removed to solidify particles in the dispersed phase; and the solidified particles in the dispersed phase are removed from the suspension. The second thermosetting powder coating is characterized in that the resin solution contains: epoxy group-containing acrylic resin; a carboxylic group- or carboxylic anhydride group-containing compound as a first curing agent; and a blocked multifunctional isocyanate compound as a second curing agent, and that the blocked multifunctional isocyanate compound is contained at a concentration of 0.3 to 20% by weight relative to the solid content of the coating to be prepared.

The volume average particle diameter of the second thermosetting powder coating of the present invention is not particularly limited. However, from the view point of production efficiency and surface smoothness of the resultant coated film, the second thermosetting powder coating preferably has the volume average particle diameter of 5 to 30 μm. If the volume average particle diameter is less than 5 μm, production efficiency and coating efficiency at a time of a coating process tend to be reduced. Meanwhile, if it is greater than 30 μm, the resultant coated film tends to have a poor surface smoothness.

Moreover, components, which are derived from the epoxy group-containing acrylic resin, are preferably contained in the second thermosetting powder coating of the present invention at a concentration of 30 to 80% by weight relative to the solid content of the second thermosetting powder coating. If the content of these components is below the lower limit, thermosetting property tends to be reduced. Meanwhile, if it exceeds the upper limit, blocking resistance of the coating component tends to be reduced.

Moreover, components, which are derived from the carboxylic group- or carboxylic anhydride group-containing compound, are preferably contained in the second thermosetting powder coating of the present invention at a concentration of 10 to 60% by weight relative to the solid content of the second thermosetting powder coating. If the content of these components is below the lower limit, thermosetting property tends to be reduced. Meanwhile, if it exceeds the upper limit, blocking resistance of the coating tends to be reduced.

Moreover, the blocked multifunctional isocyanate compound used as the second curing agent is contained in the second thermosetting powder coating of the present invention at a concentration of 0.3 to 20% by weight relative to the solid content of the second thermosetting powder coating. If the content of the blocked multifunctional isocyanate compound is below the lower limit, sufficient cure property cannot be provided. Meanwhile, if it exceeds the upper limit, yellowing and popping tend to occur at a time of a baking process.

Moreover, pigments, various additives and other components can be optionally added to the second thermosetting powder coating of the present invention as well. These pigments and additives are similar to those described in the preparation of the first thermosetting powder coating.

[Process for Forming a Coated Film]

A process for forming a coated film, which utilizes the first and second thermosetting powder coatings of the present invention, is not particularly limited. For example, a coated film can be formed in the following procedure: specifically, the thermosetting powder coating of the present invention is applied and adhered onto an object to be coated; and thereafter, the thermosetting powder coating on the object is heated, melting and curing the powder coating to form a coated film.

General coating processes can be adopted for application of the powder coatings. For example, the powder coatings can be applied by an electrostatic coating process or the like. For coatings that are used for undercoatings and intermediate coatings, publicly known coatings such as electrodeposition coatings and primers can be used.

Moreover, the heating temperature at which the coated films of the first and second thermosetting powder coatings of the invention are cured is preferably set to 120 to 170° C., particularly preferably 130 to 150° C. in order to secure coated film performance and suppress the occurrence of yellowing and popping. Furthermore, a heating period can be appropriately adjusted depending on the heating temperature. However, the heating period is preferably set to 5 to 40 minutes, more preferably 15 to 30 minutes.

Before applying the first and second thermosetting powder coatings, base coatings are applied to form base films. Then, the thermosetting powder coatings of the present invention may be applied on the base films. In this case, the base film and the coated film of the thermosetting powder coating may be simultaneously heated and cured.

Moreover, the object to be coated may be provided with an undercoating, or with both an undercoating and an intermediate coating. Examples of the objects to be coated include a plastic, an iron plate, a steel plate, an aluminum plate and one obtained by subjecting any one of these to a surface treatment. The heating temperature can be appropriately set depending on the used thermosetting powder coating, and is set to 100 to 200° C., for example. Further, the heating period is appropriately adjusted depending on the heating temperature.

### EXAMPLES

Hereinafter, the present invention will be concretely described based on Examples and Comparative examples. However, the present invention is not limited to the examples described below.

[Preparation of Resins A1, B1 and B2]

To reaction vessels equipped with stirrers, thermoregulators and reflux tubes, 63 parts by weight of xylene was respectively placed and heated to 130° C. Under nitrogen atmosphere, mixtures of monomers and an initiator, each of which has compositions shown in Table 1, were respectively added dropwise to the reaction vessels by spending 3 hours.

Note that, abbreviations in Table 1 denote the following compounds, and the mixing quantities shown in Table 1 are expressed as parts by weight.

GMA: glycidyl methacrylate

St: stylene

MMA: methyl methacrylate

HEMA: 2-hydroxyethyl methacrylate

IBMA: isobutyl methacrylate

TMI: dimethyl metha-isopropenyl benzyl isocyanate

t-BPO: t-butyl peroctate

ε-CL: epsilon-caprolactam

Note that, the resins A1 and B2 were provided as follows: mixtures of monomers and an initiator, having compositions shown in Table 1, were respectively added dropwise to the reaction vessels where 63 parts by weight of xylene had been placed, followed by 3 hours heat retention; thereafter, each of the resultant mixtures was cooled down to room temperature; and further, xylene was removed from each of the mixtures so that the concentration of the solid content of resin is 65% by weight. Furthermore, the resin B1 was provided as follows: a mixture of monomers and an initiator, having compositions shown in Table 1, was added dropwise to the reaction vessel where 63 parts by weight of xylene had been placed, followed by 3 hours heat retention; thereafter, the resultant mixture was cooled down to 90° C.; epsilon-caprolactam (a block agent) is then added to the mixture in an amount described in Table 1; followed by 3 hours heat retention, then by cooling down to room temperature; and further, xylene was removed from the mixture so that the concentration of the solid content of resin is to be 65% by weight.

Moreover, a SP value, a glass transition temperature (Tg) and a number-average molecular weight (Mn) were measured for each resin. Note that the SP value was measured by turbidity method, Tg was measured using DSC220C (manufactured by Seiko Instruments Inc., temperature-rising rate: 5° C./min). Furthermore, the number-average molecular weight was measure by using gel permeation chromatography (GPC). The property values thus measured are shown in Table 1.

TABLE 1

| | | | Resin A1 | Resin B1 | Resin B2 |
|---|---|---|---|---|---|
| Mixing | Monomers | GMA | 45 | 45 | 45 |
| Compounds | | St | 20 | 20 | 20 |
| | | MMA | 27 | 12 | 12 |
| | | HEMA | 3 | — | — |
| | | IBMA | 5 | 18 | 23 |
| | | TMI | — | 5 | — |
| | Initiator | t-BPO | 8 | 7 | 7 |
| | Blocking | ε-CL | — | 2.8 | — |
| | Agent | | | | |

| | | | | |
|---|---|---|---|---|
| Properties | SP | 10.5 | 10.2 | 10.3 |
| | Tg | 70 | 39 | 40 |
| | Mn | 3000 | 3500 | 3500 |

### Examples 1 to 2 and Comparative Examples 1 to 2

### Preparation of a Curing Agent-Dispersion

A curing agent-dispersion (solid content: 30% by weight) was prepared by mixing 75 parts by weight of 1,10-decanedicarboxylic acid with 25 parts by weight of sebacic acid, by dispersing the resultant mixture into xylene, and by pulverizing the mixture using a sand grinding mill.

[Preparation of a Solid Curing Agent C2]

The solid curing agent C2 (a blocked multifunctional isocyanate compound) was prepared as follows: 100 parts by weight of tetramethylxylylenediisocyanate, 34 parts by weight of epsilon-caprolactam and 36 parts by weight of n-heptane were placed into a reaction vessel equipped with a stirrer and a themoregulator; the resultant mixture was heated to 90° C., followed by 3 hours heat retention under nitrogen atmosphere; after having cooled down to 40° C., solid was removed from the mixture by suction filtration; and the resultant solid was dried at 30° C. using a vacuum drier.

[Preparation of Thermosetting Powder Coatings]

Using the coating compounds shown in Table 2, the thermosetting powder coatings of Examples 1 to 2 and Comparative examples 1 to 2 were produced. That is, firstly, materials for the coating compounds were mixed using a sand grinding mill to prepare resin solutions. The resin solutions were added to polymer-containing aqueous solutions, each of which consisting of 6 parts by weight of GOHSENOL GH-20 (polyvinyl alcohol manufactured by Nippon Synthetic Chemical Industry Co., Ltd, the degree of saponification: 88%, no cloud point), 3 parts by weight of GOHSENOL KL-05 (polyvinyl alcohol manufactured by Nippon Synthetic Chemical Industry Co., Ltd, the degree of saponification: 80%, cloud point: around 80° C.), 1 part weight of hydroxypropylcellulose (cloud point: around 50° C.) and 90 parts weight of ion-exchanged water. The resultant mixtures were further agitated and mixed at 25° C. using a homogenizer. In this way, suspensions were prepared that contain particles with a volume average particle diameter of 5.0 μm in the dispersed phase.

Note that, mixing quantities shown in Table 2 are expressed as parts by weight. In addition, “YF3919” in Table 2 is the polysiloxane surface control agent manufactured by Toshiba Silicone Co., Ltd. “curing agent-dispersion” and “solid curing agent C2” are ones that were produced in the above-described preparation process for the curing agent-dispersion. Furthermore, “ultraviolet absorber” is the TINUVIN928 (manufactured by Ciba Specialty Chemicals Co., Ltd), and “antioxidant” is the TINUVIN144 (manufactured by Ciba Specialty Chemicals Co., Ltd).

Next, 300 parts by weight of ion-exchanged water was added to each resultant suspension for dilution. Then, the diluted suspensions were transferred to vessels equipped with stirrers, thermoregulators, reflux tubes and vacuum system. After reducing the pressures in the vessels to 30 Torr, the suspensions were heated to 35° C., whereby primary particles were formed in the dispersed phases. Subsequently, after reducing the pressures in the vessels to 140 Torr, the suspensions were heated to 57° C. to aggregate the primary particles. Thus, secondary particles with a volume average particle diameter of 10 μm were formed. Note that, the particle diameter was measured with Coulter Counter (manufactured by Coulter Electronics, Inc). After that, organic solvents were completely removed out of the dispersed phases of the suspensions, thereby solidifying the secondary particles in the dispersed phases.

After having solidified the secondary particles, the suspensions with the solidified secondary particles were cooled down to 30° C. Thereafter, the suspensions were filtered by suction to separate the secondary particles therefrom. The resultant particles were dried at 30° C. using a vacuum drier. Thus, thermosetting powder coatings were provided. Note that, using the Coulter Counter (manufactured by Coulter Electronics, Inc), a volume average particle diameter (dw) and a number-average particle diameter (dn) were measured for each resultant powder coating. Measurement results are shown in Table 2.

### Comparative Examples 3 to 5

### Preparation of a Solid Curing Agent C1

The solid curing agent C1 was prepared by mixing 75 parts by weight of 1,10-decanedicarboxylic acid with 25 parts by weight of sebacic acid, and by pulverizing the resultant mixture with a jet mill, so that the mixture has a volume average particle diameter of 3 μm.

[Preparation of Powder Coatings]

Thermosetting powder coatings were produced by the conventional dry-process. Specifically, organic solvents were removed from resin solutions A1, B1 and B2 to provide solid resins. Using these solid resins as materials, materials for coating compounds shown in Table 2 were mixed by using a Henschel mixer. The resultant mixtures were further melted and mixed at the set temperature of around 95° C. by use of the Buss ko-kneader. After that, the resultant melted mixtures were cooled down to room temperature and were roughly pulverized using the Henschel mixer again, followed by further pulverization with a hammer mill. Then, a jet mill was used to for finer pulverization. Note that, using the Coulter Counter (manufactured by Coulter Electronics, Inc), a volume average particle diameter (dw) and a number-average particle diameter (dn) were measured for each resultant powder coating. Measurement results are shown in Table 2.

TABLE 2

| | | | | Comparative | | | |
|---|---|---|---|---|---|---|---|
| | | Example | Example | examples | Comparative | Comparative | Comparative |
| | | 1 | 2 | 1 and 2 | example 3 | example 4 | example 5 |
| Production process | | Suspension method | | | Pulverization method | | |
| Compounds contained in | Resin A1 | 24 | 24 | 24 | — | — | — |
| coatings | (solid | | | | | | |
| | content 65%) | | | | | | |
| | Resin B1 | 96 | — | — | — | — | — |
| | (solid | | | | | | |
| | content 65%) | | | | | | |
| | Resin B2 | — | 91.4 | 96 | — | — | — |
| | (solid | | | | | | |
| | content 65%) | | | | | | |
| | Solid resin A1 | — | — | — | 15.6 | 15.6 | 70 |
| | Solid resin B1 | — | — | — | 62.4 | — | — |
| | Solid resin B2 | — | — | — | — | 59.4 | — |
| | Curing agent- | 75 | 75 | 75 | — | — | — |
| | dispersion | | | | | | |
| | Solid curing | — | — | — | 22 | 22 | 5 |
| | agent C1 | | | | | | |
| | Solid curing | — | 3 | — | — | 3 | 25 |
| | agent C2 | | | | | | |
| | YF3919 | 0.1 | 0.1 | 0.1 | 0.1 | 0.1 | 0.1 |
| | Benzoine | 0.3 | 0.3 | 0.3 | 0.3 | 0.3 | 0.3 |
| | Ultraviolet | 1.2 | 1.2 | 1.2 | 1.2 | 1.2 | 1.2 |
| | absorber | | | | | | |
| | Antioxidant | 1 | 1 | 1 | 1 | 1 | 1 |
| Proportion of B1 contained | | 3 | 2.9 | 0 | 3 | 2.9 | 25 |
| in the solid content of the | | | | | | | |
| coating (wt %) | | | | | | | |
| Properties | Particle | 10 | 10 | 10 | 10 | 10 | 10 |
| | diameter of | | | | | | |
| | coatings (dw) | | | | | | |
| | dw/dn | 2.4 | 2.5 | 2.4 | 4.7 | 4.7 | 4.8 |

[Evaluation of Powder Coatings Obtained in the Examples and Comparative Examples]
[G Value, F Value and Δb Value]

The thermosetting powder coatings obtained in the Examples and Comparative examples were used to produce coated films in the following procedure. For each obtained coated film, G value, F value and Δb value were measured in the following procedure.

Specifically, in the first place, water-based metallic base coatings (brand name: AQUAREX 2000 #1C0, manufactured by Nippon Paint Co., Ltd) were electrostatically applied on the substrates on which intermediate coatings had been applied, so that the substrates had a dry film thickness of 15 μm. Subsequently, the obtained substrates were pre-dried at 80° C. for 10 minutes in a hot drying furnace. After the substrates were cooled down to room temperature, each of the powder coatings obtained in the Examples and Comparative examples was electrostatically applied on the substrates. Here, the coating powders obtained in the Examples, Comparative example 1 and Comparative examples 3 to 5 were heated at 140° C. for 25 minutes. Meanwhile, the powder coating obtained in the Comparative example 2 was heated at 140° C. for 50 minutes. Thus, the powder coatings were cured with the water-based metallic coatings. In this way, coated films with a thickness of 40 μm, which are constituted of thermosetting powder coatings, were formed.

It should be noted that the substrate that has the intermediate coating and produced in the following procedure was used: specifically, an electrodeposition coating for automobiles (manufactured by Nippon Paint Co., Ltd, brand name: POWERNIX 110 GRAY) was electrostatically applied on a dull steel sheet which had been subjected to a zinc phosphate treatment so that it had a dry film thickness of 25 μm, followed by baking at 160° C. for 25 minutes; and the intermediate coating (manufactured by Nippon Paint Co., Ltd, brand name: OLGA P-30) was then electrostatically applied on the resultant substrate to have a dry film thickness of 40 μm, followed by baking at 140° C. for 25 minutes.

Next, for each resultant coated film, G value and F value were measured with “Wave Scan-T” (product name: manufactured by BYK-Gardner Co., Ltd). Thus, the appearance was evaluated for each coated film. Note that, G value is a parameter mainly representing the degree of gloss. A glossy coated film has a smaller G value, and coated films with G value of 10 or less make the grade. In addition, F value is a parameter mainly representing a surface smoothness, a coated film with an excellent surface smoothness has a larger F value, and coated films with a F value of 4.5 or above make the grade. (See reference “Coating Technology” by Ishiai Kazuo, Vol. 30, No. 7, Page 301, (1995)). G value and F value of the resultant coated films are shown in Table 3.

Moreover, in order to measure the degree of coloring (yellowing) of the coated film at a time of a baking process, Δb value was measured for each coated film by use of a calorimeter (product name: SM-T45, manufactured by Suga Test Instruments Co., Ltd). Note that, b value represents the degree of yellowing of a coated film, and each of Δb value shown in Table 3 is the difference between b value, measured when the pre-drying of the water-based metallic base coating is finished, and b value measured after the powder clear coating is cured. In addition, smaller Δb value means that the clear coating has a smaller degree of coloring (yellowing) at a time of a baking process, and those with 0.5 or less make the grade. The Δb values of the resultant coated films are shown in Table 3.

[Oil Resistance]

For each thermosetting powder coating obtained in the Examples and Comparative examples, oil resistance was measured in the following procedure: specifically, 0.2 ml of xylene was dropped on each resultant test plate; the test plates were then allowed to stand at 25° C. for 30 minutes; xylene was removed from each test plate; and conditions of each test plate were observed. Furthermore, evaluations of oil resistance of each resultant coated film are shown in Table 3. It should be noted that the following evaluation criteria was employed.

Excellent: The coated film never swelled and melted

Poor: The coated film swelled and melted

[Crosslink Density of Coated Films]

Each of the thermosetting powder coatings obtained in the Examples and Comparative examples was electrostatically applied on a tin plate, followed by heating at 140° C. for 25 minutes. Thus, coated films with a film thickness of about 70 μm were formed. For each coated film, crosslink density was measured by the dynamic viscoelasticity measurement using PHEOVIBRON (manufactured by Orientech, Inc), where microvibration was applied to samples. The crosslink density of each resultant coated film is shown in Table 3.

TABLE 3

| | | | Comparative | Comparative | Comparative | Comparative | Comparative |
|---|---|---|---|---|---|---|---|
| | Example 1 | Example 2 | example 1 | example 2 | example 3 | example 4 | example 5 |
| | Production process | | | | | | |
| | Suspension method | | | | Pulverization method | | |
| Baking time | 25 | 25 | 25 | 50 | 25 | 25 | 25 |
| Appearance | 7 | 7 | 7 | 7 | 17 | 18 | 22 |
| (G value) | | | | | | | |
| Appearance | 5.2 | 5.1 | 5.2 | 5.2 | 3.9 | 3.8 | 3.4 |
| (F value) | | | | | | | |
| Appearance | 0.37 | 0.41 | 0.31 | 0.78 | 0.38 | 0.4 | 4.08 |
| (Δb value) | | | | | | | |
| Oil | Excellent | Excellent | Poor | Excellent | Excellent | Excellent | Excellent |
| resistance | | | | | | | |
| Crosslink | 1.18 | 1.11 | 0.91 | 1.16 | 1.15 | 1.07 | 1.06 |
| density | | | | | | | |
| (mmol/cc) | | | | | | | |

The thermosetting powder coatings obtained in the Examples 1 and 2 exhibited excellent appearance, surface gloss and smoothness, and furthermore, crosslink density was excellent. On the other hand, the thermosetting powder coating obtained in the Comparative example 1 exhibited low crosslink density, and low crosslink density at a low temperature (140° C.) baking. Further, the thermosetting powder coating obtained in the Comparative example 2 exhibited a poor degree of yellowing (Δb value). Furthermore, the thermosetting powder coatings obtained in the Comparative examples 3 and 4 exhibited poor surface gloss and smoothness. The thermosetting powder coating obtained in the Comparative example 5, where blocked multifunctional isocyanates is mainly used as a curing agent, exhibited insufficient surface gloss and smoothness, as well as poor Δb value.

### INDUSTRIAL APPLICABILITY

As described above, according to the present invention, it is possible to provide a thermosetting powder coating and a process for producing the same, the thermosetting powder coating having sufficiently enhanced low-temperature cure property, effectively preventing occurrence of yellowing and so-called popping to allow for provision of a coated film with high-grade crosslink density and appearance even when baked and cured at a relatively low temperature, and being suited for application for pale colors as well as deep colors, all of which can be achieved in spite of the fact that the thermosetting powder coating is produced by a so-called wet process.

Accordingly, the thermosetting powder coatings of the present invention are not only friendly to the environment but also useful as coatings and the like for automobile bodies, which give coated film with excellent appearance and allow for pale-colored design.

1. A thermosetting powder coating obtained by the following procedure:
preparing a suspension by dispersing a resin solution containing an organic solvent into an aqueous solution containing a water-soluble polymer;
removing the organic solvent in a dispersed phase from the suspension;
solidifying particles in the dispersed phase; and
removing the solidified particles in the dispersed phase from the suspension,
wherein the resin solution contains: acrylic resin containing an epoxy group and a blocked isocyanate group; and a carboxylic group- or carboxylic anhydride group-containing compound as a curing agent.

2. The thermosetting powder coating according to claim 1, wherein the isocyate group is a tertiary isocyanate group.

3. A thermosetting powder coating obtained by the following procedure:
preparing a suspension by dispersing a resin solution containing an organic solvent into an aqueous solution containing a water-soluble polymer;
removing the organic solvent in a dispersed phase from the suspension;
solidifying particles in the dispersed phase; and
removing the solidified particles in the dispersed phase from the suspension,
wherein the resin solution contains: epoxy group-containing acrylic resin; a carboxylic group- or carboxylic anhydride group-containing compound as a first curing agent; and a blocked multifunctional isocyanate compound as a second curing agent, and
wherein the content of the blocked multifunctional isocyanate compound is 0.3 to 20% by weight relative to the solid content of the coating to be prepared.

4. The thermosetting powder coating according to claim 3,
wherein the blocked multifunctional isocyanate compound is at least one selected from the group consisting of a diisocyanate compound having a tertiary isocyanate group, an adduct of the diisocyanate compound and an isocyanurate of the diisocyanate compound.

5. A process for producing a thermosetting powder coating, comprising the steps of:
preparing a suspension by dispersing a resin solution containing an organic solvent into an aqueous solution containing a water-soluble polymer;
removing the organic solvent in a dispersed phase from the suspension;
solidifying particles in the dispersed phase; and
removing the solidified particles in the dispersed phase from the suspension,
wherein the resin solution contains: acrylic resin containing an epoxy group and a blocked isocyanate group; and a carboxylic group- or carboxylic anhydride group-containing compound as a curing agent.

6. The process for producing a thermosetting powder coating according to claim 5,
wherein the isocyate group is a tertiary isocyanate group.

7. The process for producing a thermosetting powder coating according to claim 5,
wherein the water-soluble polymer is a mixture of a water-soluble polymer with no cloud point and a water-soluble polymer with a cloud point in a range of 30 to 90° C., and the process comprises the steps of:
(1) preparing a suspension by dispersing a resin solution containing the organic solvent into an aqueous solution containing the water-soluble polymer at a temperature below the cloud point;
(2) heating the suspension to a temperature below the cloud point to form primary particles in the dispersed phase;
(3) heating the suspension containing the primary particles to a temperature the cloud point or above, whereby the primary particles are aggregated to form secondary particles, as well as removing an organic solvent in the secondary particles to solidify the particles; and
(4) removing the solidified particles in the dispersed phase from the suspension.

8. A process for producing a thermosetting powder coating, comprising the steps of:
preparing a suspension by dispersing a resin solution containing an organic solvent into an aqueous solution containing a water-soluble polymer;
removing the organic solvent in a dispersed phase from the suspension;
solidifying particles in the dispersed phase; and
removing the solidified particles in the dispersed phase from the suspension,
wherein the resin solution contains: epoxy group-containing acrylic resin; a carboxylic group- or carboxylic anhydride group-containing compound as a first curing agent; and a blocked multifunctional isocyanate compound as a second curing agent, and
wherein the content of the blocked multifunctional isocyanate compound is 0.3 to 20% by weight relative to the solid content of the coating to be prepared.

9. The process for producing a thermosetting powder coating according to claim 8,
wherein the blocked multifunctional isocyanate compound is at least one selected from the group consisting of a diisocyanate compound having a tertiary isocyanate group, an adduct of the diisocyanate compound and an isocyanurate of the diisocyanate compound.

10. The process for producing a thermosetting powder coating according to claim 8,
wherein the water-soluble polymer is a mixture of a water-soluble polymer with no cloud point and a water-soluble polymer with a cloud point in a range of 30 to 90° C., and the process comprises the steps of:
(1) preparing a suspension by dispersing a resin solution containing the organic solvent into an aqueous solution containing the water-soluble polymer at a temperature below the cloud point;
(2) heating the suspension to a temperature below the cloud point to form primary particles in the dispersed phase;
(3) heating the suspension containing the primary particles to a temperature the cloud point or above, whereby the primary particles are aggregated to form secondary particles, as well as removing an organic solvent in the secondary particles to solidify the particles; and
(4) removing the solidified particles in the dispersed phase from the suspension.
